(19) United States
(12) Patent Application Publication
(10) Pub. No.: US 2003/0222366 A1
(43) Pub. Date: Dec. 4, 2003

(54) Production of dental restorations and other custom objects by free-form fabrication methods and systems therefor

(76) Inventors: Ivan Stangel, Bethesda, MD (US); Walter R. Zimbeck JR., Annapolis, MD (US)

Correspondence Address: Kendrew H. Colton, Fitch, Even, Tabin & Flannery, Suite 401L, 1801 K. Street, N.W., Washington, DC, 20006-1201, US

(21) Appl. No.: 10/324,102

(22) Filed: Dec. 20, 2002

Related U.S. Application Data
(60) Provisional application No. 60/341,789, filed on Dec. 21, 2001.

(51) Int. Cl. A61C 13/00

(52) U.S. Cl. 264/16

(57) ABSTRACT

Dental restoration production in which a digitized optical impression of a dental restoration site is captured using an intra-oral camera, and the captured optical impression is converted into a data file usable for computer-assisted production of all-ceramic or composite resin dental restorations using a fabrication system based on stereolithography.

### CROSS-REFERENCE TO RELATED APPLICATIONS

This application claims the benefit of priority under 35 U.S.C. § 119(e) to U.S. Provisional application serial No. 60/341,789, filed Dec. 21, 2001, the entire disclosure and contents of which are incorporated herein by reference for all purposes.

### TECHNICAL FIELD

The present invention generally relates to production of dental restorations by an additive layer-by-layer, free form fabrication method and system. The technique with the materials can additionally be used in other biomedical and industrial areas where strong ceramic and polymer-matrix composites can be used.

### BACKGROUND ART

Dental restorations are often needed to correct tooth deterioration caused by decay or wear that cannot be repaired by fillings and the like. They also are used to to treat a tooth that has suffered significant physical damage, such as a chip, break or crack. In restoring the tooth under these types of circumstances, an important objective is to replicate the original morphology of the tooth as much as possible. This is an important goal not only for the sake of aesthetic appearance, but also for functional reasons, such as to restore physiologic function, maintain the health of the periodontium (gums and supporting bone), accommodate adjoining teeth and the chewing motions of opposing teeth. Restoration of the tooth in these instances often necessitates an inlay, onlay or crown.

All-ceramic materials, such as porcelain, have been commonly used in making such dental restorations. Non-metallic dental restorations generally offer advantages over conventional metal-based restorations in terms of biocompatability, chemical inertness, wear resistance, and aesthetics.

Unfortunately, conventional manual fabrication techniques used for preparing all-ceramic and polymer composite dental restorations are time consuming and labor intensive. The dentist must take an impression of the tooth to be restored, and a die stone or model is prepared as cast from the impression mold. The die stone is used by a dental lab technician, who typically is located in a remote laboratory from the dentist, to fabricate the final restoration, which is then shipped back to the dentist for installation in the patient. The time required for such a manual fabrication process can encompass numerous days or even weeks, and the cost of such a manual approach in terms of work-hours and materials is relatively high.

As efforts to avoid these and other drawbacks associated with manual fabrications of dental restorations, computer assisted design/computer assisted milling (CAD/CAM) processes and equipment have been introduced into the dental industry to automate aspects of the fabrication of all-ceramic dental restorations. Commercially available CAD/CAM systems in this regard, include, for example, the CEREC II system of Siemens, A. G., and the PROCERA All-Ceram system of Nobel Biocare AD.

The CEREC II system is a chair-side serial process for fabrication of restorations that uses optical imaging to digitize the surface of the prepared site, and software to design the complete restoration (i.e., the occlusal and proximal surfaces). Once an image is obtained, and a design made, the restoration is milled from a block of machinable ceramic material from the surface data of the digitized representation. After milling, the sprue is removed. If the fit is satisfactory, the internal surfaces of the restoration are etched, primed with a silane coupling agent, and the restoration is bonded to the prepared site using a prescribed dual light curing resin cement. Final finishing and polishing are performed as necessary.

However, the machining steps employed restrict the choice of materials for the dental restoration to machinable ceramics and polymer composites. Machinable ceramics can often be comprised of non-optimal ceramic compositions from standpoints of durability, strength or aesthetic qualities, for dental restorations. Also, a cutting tool used for such machining procedures can be used to machine only one restoration part at a time, which effectively slows production. Cutting tools must also be replaced due to wear during cutting, which adds to the fabrication costs.

The Procera All-Ceram system is a laboratory-based serial approach to fabricating all-ceramic restorations. The restorations consist of a high purity alumina coping with a porcelain veneer. The Procera process starts with the dentist preparing the restoration site, and taking a conventional impression. The impression is sent to a “spoke” laboratory where a die stone is cast from the impression mold. The surface of the die stone is scanned using a sapphire tipped probe and a turntable that rotates the die as the probe moves up and down. A very accurate digitized surface model is produced, and a CAD software package is used to design the coping based on this surface. The CAD representation of the coping and die stone surface are sent to the “hub” laboratory electronically, where a duplicate die stone is CNC (computer numerically controlled, i.e., directly from the digitized surface data) ground with a 20% enlargement factor. High purity alumina powder is compacted against the die stone in the form of the desired restoration and some light machining is done to achieve the desired coping dimensional specifications. The coping is then fired to high density, undergoing 20% linear shrinkage during densification. The coping is then sent back to the spoke laboratory where a Procera All-Ceram porcelain (matched for color) is applied over the coping to build up the occlusal and proximal shape. A lower temperature firing results in good bonding between the porcelain and the coping and densities the porcelain giving good esthetic and tribological characteristics. The completed restoration is then sent back to the dental office for cementing using standard luting agents. Such a conventional CAD/CAM system cannot produce full crowns, as some manual building and firing of porcelain layers on top of a coping received from a CAD/CAM facility is required. The Procera approach is relatively complex involving two different laboratories (spoke and hub) and multiple steps, and like the Cerec system, is a serial process. Both factors contribute to long-turn around time and a high number of work-hours/restoration.

Improved approaches to the fabrication of dental restorations that achieve a high degree of precision and automation in a relatively short period of time remain highly desired in the dental care industry.

### SUMMARY OF THE INVENTION

The above problems and shortcomings are solved at least in part by the present invention in which a digitized optical impression of a dental restoration site is captured using an intra-oral camera, and the captured optical impression is converted into a data file usable for computer-assisted production of all-ceramic or composite resin dental restorations using a fabrication system based on stereolithography. In one preferred embodiment of this invention, a stereophotolithographic fabrication system is used in this respect, which is an additive, layer-by-layer free form fabrication scheme involving direct layered manufacturing of solid dental restorations.

In one embodiment of the present invention, there is a process for manufacturing a dental restoration in which a digital image is acquired of a three-dimensional topography of a dental restoration site (i.e., a tooth to be restored) using an intra-oral camera. In another embodiment, the digital image of the restoration site is acquired from an impression using a table top digitizing camera. In both embodiments a data file is then generated of the three-dimensional shape of the desired restoration based on the acquired digital image. Free form fabrication of the dental restoration can proceed at this point. A layer comprising photocurable material and ceramic material is deposited, which is selectively exposed to actinic radiation in a pattern based on the data file effective to define at least a partly hardened pattern therein corresponding to a cross-section of the shape of the restoration at a given thickness level thereof. The layer region that is exposed to the actinic radiation is determined by computing the area of intersection between the desired plane or cross-section and the computer-assisted representation of the shape in question. The layer depositing and selective exposure steps are then repeated a plurality of times effective to produce a plurality of layers of ceramic composite material at different thickness levels of the restoration. These layers are stacked on one another and integrally bonded together to effectively form the three-dimensional shape of the desired restoration. The hardening of the three-dimensional shape is advanced to form the dental restoration.

In one preferred embodiment, the data file is a computer-assisted design (CAD) file. The photocurable material can be photopolymerizable (photocrosslinkable) material, such as acrylate-based polymer precursors. The ceramic material can be alumina, aluminosilicate, apatite, fluoroapatite, hydroxyapatite, mullite, zirconia, silica, spinel, tricalcium phosphate, and mixtures thereof. In one preferred embodiment, the dental restoration is a sintered ceramic derived from firing a combination of alumina powder and a temporary photopolymerizable matrix resin. In another preferred embodiment, the dental restoration is a polymer-matrix composite, preferably containing aluminosilicate particles and a photopolymerizable matrix resin.

The automated free form fabrication process and system of this invention yields high resolution, highly accurate dental restorations while building up layers comprised of resin and ceramic materials having a viscosity in the range of 200 to 3.5 million centipoise (cps). The particular rheology should be tailored based on the method used to apply the thin layers of material. Generally, a shear thinning rheology is desired, such that thin (down to 0.001″ and less), uniform layers can be applied.

The high precision dental restorations that can be fabricated according to the invention in a highly automated manner are not particularly limited, and include crowns, onlays, inlays, bridges, fillings, denture teeth, and replacement bone for dental and other reconstructive surgery, and so forth. In the case of a dental crown or tooth and the like, the fabrication of the complete restoration can be automated, including fabrication of the occlusal and proximal surfaces of the restoration.

The dental restoration fabrication methods and systems of this invention make it possible to significantly increase efficiency and reduce costs of operation to both dental practices and dental laboratories. In the case of dental practices, it reduces the time and cost associated with taking impressions, as well as reduces patient anxiety as the impression “taking” is less invasive. For dental laboratories, it automates the fabrication process and replaces conventional serial approaches with a batch process that can build numerous different restorations simultaneously.

Moreover, this invention makes it possible to integrate an optical imaging system that digitizes tooth surfaces that need to be constructed, and either electronically send the data file to a lab, such as via the Internet or world wide web, for example, where the part will be constructed, or send it to a device that a dental practitioner will use in his or her own office. In addition, the process includes software to convert the digitized image to a computer-assisted manufacturing file, such as an STL file, which can be used to direct operation of the free form fabrication system. Thus, this invention encompasses a three-part system including image acquisition, software manipulation of the data, followed by the free form manufacturing process.

### BRIEF DESCRIPTION OF THE DRAWINGS

Other features, objects, and advantages of the present invention will become apparent from the following additional description of the invention with reference to the drawings, in which:

FIG. 1 is a flowchart of a process for digital free form fabrication of dental restorations according to an aspect of the invention;

FIG. 2 is a flow diagram of a process for digital free form fabrication of dental restorations according to another aspect of the present invention;

FIG. 3 is a plot of the particle distribution of a sinterable alumina powder used in an Example described herein;

FIG. 4 is a scanning electron micrograph (SEM) of the surface of a built sample according to an example of the invention;

FIG. 5 is an SEM of the surface of a built sample according to an example of the invention;

FIG. 6 is an SEM micrograph of the surface of a built sample according to an example of the invention;

FIG. 7 is a photograph of a molar model made according to the invention;

FIG. 8 is a digitized image of the molar model of FIG. 8 acquired with a 3D camera; and

FIG. 9 is a cross-section of a tooth fabricated according to an example of the invention.

Skilled artisans will appreciate that elements in the figures are illustrated for simplicity and clarity and have not necessarily been drawn to scale.

### DETAILED DESCRIPTION OF THE INVENTION

A process for the direct fabrication of solid-objects having a desired geometry, which may involve the following steps, is now described with reference to a presently preferred embodiment. Although a presently described preferred embodiment is in the field of dentistry, it will be appreciated that other applications, such as custom fabrication of other body parts, are also suitable.

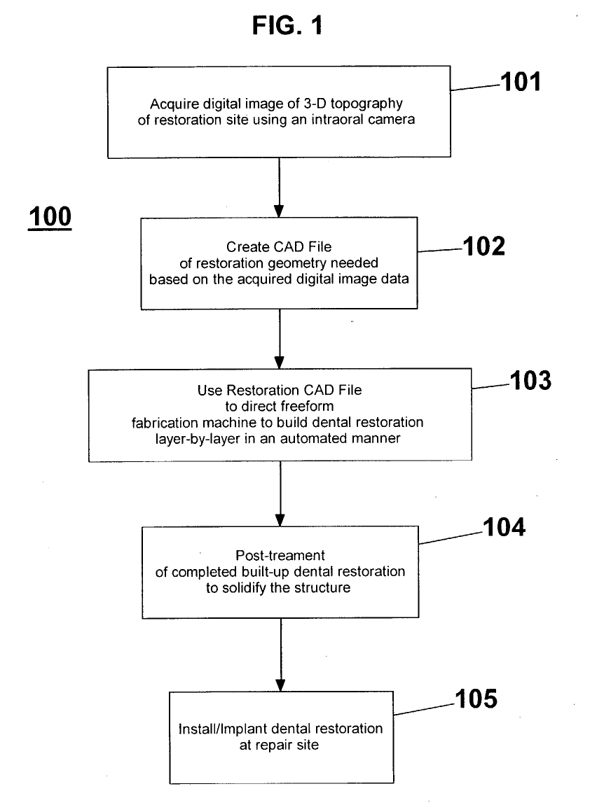

A generalized process flow 100 for the invention described herein is set forth in FIG. 1, as steps 101-105.

The site for inserting the solid object is prepared. For instance, a cavity preparation may be an example of site preparation. An image of the prepared site, such as a cavity preparation, is obtained. The image is preferably digital and capable of being converted to a three-dimensional representation, corresponding in suitable scale of the prepared site. Most advantageously the scale is 1:1. The image is digitized and a digital 3-D image obtained. The digitized image can be manipulated to be a computer-assisted design (CAD) file or other similar file that is capable of being used to control subsequent steps in the formation of the solid object corresponding to the prepared site. The control can be implemented using suitable computer controlled fabrication apparatus.

The CAD file or similar functioning file is used to control a layer-by-layer build up in obtaining the solid object. The layer-by-layer build up is sometimes referred to as stereolithography, rapid prototyping or layered manufacturing. For example, the restoration can be prepared in areas of sequentially deposited wet coating layers which are each imagewise-exposed to radiation effective to define a cross-sectional slice corresponding to the computer assisted design file information obtained via the optical impression taken of the restoration site by an intra-oral camera. Each layer is created by spreading a thin layer of viscous fluid, gel or paste like consistency material over the surface. The material used for layered manufacturing generally has a viscosity in the range of 200 to 3.5 million cPs, but most importantly should have a rheology that allows application of thin layers by blade casting, extrusion, spray deposition or similar method for achieving thin layers or uniform thickness. The rheology generally but not necessarily may be in the range of 200 to 3,500,000 cPs, more particularly in the range of 30,000 to 200,000 cPs, and even more particularly, in the range of 40,000 to 100,000 cPs.

Instructions for each layer may be derived directly from a CAD representation of the restoration. For instance, the area to be exposed is obtained by computing the area of intersection between the desired plane and the CAD representation of the object. All the layers required for an aesthetically and functionally acceptable restoration can be deposited sequentially cross-section after cross-section and thereafter are sintered or cured simultaneously. The amount of green body oversize is equivalent to the amount of shrinkage, which is anticipated to occur during sintering or curing. While the layers become hardened or at least partially hardened as each of the layers is laid down, once the desired final shaped configuration is achieved and the layering process is complete, in some applications it may be desirable that the form and its contents be heated or cured at a suitably selected temperature to further promote consolidation of the layers into an integral shape. The individual sliced segments or layers are joined by resin binder ingredients in the layers to form the three dimensional structure.

The compositions suitably employed in fabricating each layer can be the same or different. The compositions employed can be selected so that the solid object to be fabricated exhibits a desired set of characteristics, including hardness, color and the like. The compositions are by present preference curable compositions. Dental applications include particulate or fiber reinforced dental composites, including certain ceramics. The initial curing can be accomplished using UV or visible photo-initiated or electron beam-initiated curing mechanisms.

Preferably, each layer is deposited and at least partially cured prior to deposition of each succeeding layer. Each layer is at least partially hardened after its deposition via the patterned exposure with actinic radiation sufficient that it does not distort when the next successive layer is coated thereon. If each layer is individually fully hardened before the next successive layer is applied thereover, that can significantly increase fabrication time. When the final layer is layered on the penultimate layer, a final or secondary curing step can be performed so that the final solid object is further hardened.

Accordingly, at the completion of this present preferred embodiment, a discrete solid object is obtained that corresponds to the site preparation and is physically capable of being inserted into or onto the site. For instance, the object can be a veneer, crown or filling, which in the last mentioned case means that it can fit into the cavity preparation and be adhered in place. As will be appreciated, the solid object fabricated by this invention is not particularly limited and can be a dental prosthetic, crown, inlay, onlay, tooth denture, bridge, filling, bone replacement for reconstructive dental surgery, and so forth. Suitable adhesives for adhering the solid object in place for dental applications include conventional dental adhesives used for that purpose.

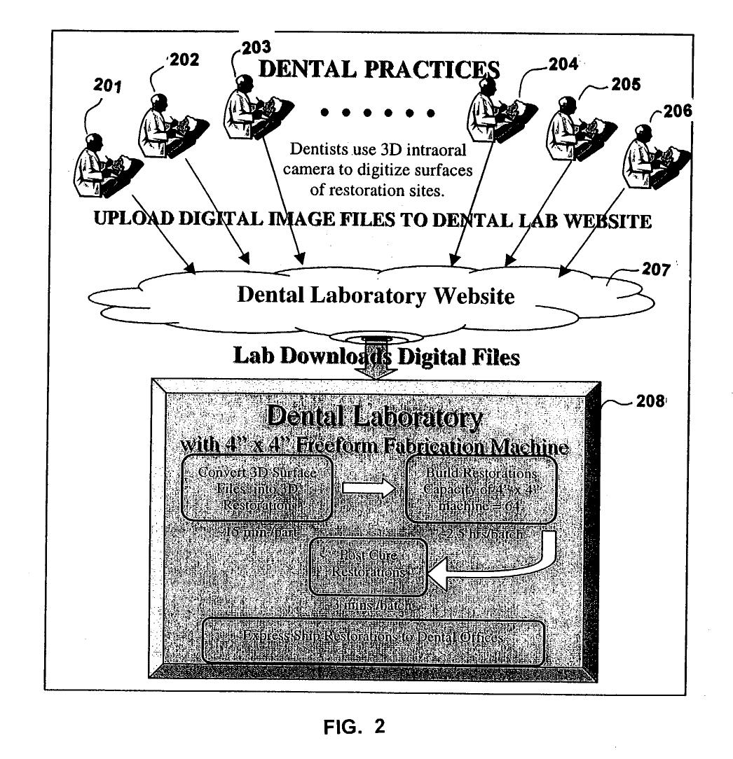

A commercial process flow for the proposed technology is shown schematically in FIG. 2. Dental practices at different locations, such as nationwide, use 3D intraoral cameras to digitize the surfaces of restoration sites, as well as occlusal and proximal surfaces, if necessary. An office assistant uploads the image file(s) to the Dental Laboratory web site (e.g., via FTP or email). The laboratory downloads the files and generates a 3D CAD file of the restoration using the expert system software. As other orders are received by the lab, the respective 3D CAD files of the restorations are created and the lab technician situates them on the virtual build platform. When the build platform is filled to capacity, the build is started and the restorations are built simultaneously, layer-by-layer. Build rates of the order of 3-4 layers per minute or faster, using about 0.001″ (25 micrometers) layer thickness are preferred. The layer thicknesses generally will be made uniform from layer to layer within a common stack. The thickness of the layers generally will be in the range of about 5 to 50 micrometers. Layers that are thinner will require a larger number of cross-sections to be processed to form the shape desired, while if the layers are too thick it can become difficult to maintain high precision construction of the desired restoration shape. When the build is complete, the “green state” restorations are removed from the platform and the surrounding uncured resin is rinsed away. The batch is then post processed—a post-cure for the polymer composite and a debind/sinter process for the ceramic. After quality control, each restoration is express-shipped to the originating dental practice for placement.

The direct fabrication method provided by this invention avoids the delays and associated required preparation of a wax-like substrate corresponding to the desired object, which is then used to form a mold, melted and replaced with the molding material in the mold. Avoiding the molding steps required with indirect fabrication techniques offers considerable reduction in time and costs for fabricating small parts, such as veneers, crowns or cavity fillers.

This invention also makes it possible to commercialize a fully digital process for designing and producing indirect, all-ceramic and polymer composite dental restorations. Indirectly placed ceramic and polymer composite restorations are available and have shown good results clinically, but are not widely used because of their relatively high cost compared to dental amalgam. This invention embodies an optimized automated fabrication machine and materials that are competitive with the widely-used manual fabrication or the newer CAD-CAM based fabrication techniques (e.g., CEREC II and Procera). The inventive fabrication system is based on stereolithography, a rapid prototyping technique (i.e., additive, layer-by-layer freeform fabrication). The CAD-driven system builds restorations from 3D image data acquired with high resolution 3D intra-oral camera technology.

This innovative technology significantly increases efficiency in dental laboratories by replacing the current serial approach with a batch process that can build dozens of different restorations simultaneously. Fabrication costs at large dental laboratories could easily be reduced to 10% of current costs. Presumably, market forces would pass these cost savings on to dentists and patients.

This invention has a capability to fabricate alumina-ceramic restorations with physical and mechanical properties at least as good as those identified in the ASTM F603 standard for implantable alumina.

It also has a capability to fabricate polymer composite restorations with physical and mechanical properties at least as good as the best commercial dental composite materials.

It also has a machine capability to fabricate ceramic and polymer composite restorations with high precision (a 25 micron accuracy of fit).

It also has a capability to use system software to rapidly (e.g., 15 min.) generate restoration geometry from the digital images acquired with a 3D intra-oral camera, such as a Genex 3D or Siemen's intra-oral camera.

It also makes feasible an entire digital fabrication approach from image acquisition using a 3D intra-oral camera, to creating the restoration design, and to freeform fabrication of multiple restorations simultaneously.

For example, among other implementations described herein, a three-dimensional epoxy polymer inlay has been built by the present investigators from an STL file using a stereolithography machine (3D Systems, Inc.) based on a CAD file generated using Magics software (Materialise, Inc.) and based on an optical impression of a restoration site taken with a 3D Camera, (in which 50 μm layers clearly defined the contoured topography of the restorations bottom surface). This restoration was cemented into a stereolithography-fabricated mold and cross-sectioned revealing excellent accuracy of fit.

Freeform Fabrication Machine

Primary considerations for the free form fabrication device used in the practice of this invention include resolution/accuracy, materials compatibility and relatively low production costs.

Restoration Material Properties

Non-metal restorations are of high interest for improved biocompatibility and aesthetics compared to conventional metal-based restorations. The restoration ceramic materials must have sufficient strength and toughness, but also must be compatible with the stereolithography processing used in this invention. The freeform fabrication method described here is compatible with direct fabrication of polymer composite and ceramic materials, and, therefore is consistent with current trends away from metal solutions. High purity alumina restorations, such as obtained from formulations and processing described later in the examples herein, have a flexure strength of 478 MPa, and a fracture toughness of 3.02 MPa·m^{1/2}. Composite resin restorations, such as obtained from formulations described in the examples herein, have a flexure strength of 162 MPa. These attributes of composites of the present invention are significantly greater than dental composites on the market, such as 3M Dental Z-100, having a flexure strength of 126 MPa.

Accuracy of Fit

Accuracy of fit of the restoration to the prepared site has been found to be equally as important as material properties in determining the resistance to fracture. The luting cement film thickness for a crown, as stated in the American Dental Association Specification No. 8, should be no more than 25 μm when using a Type I luting agent, and 40 μm when using a Type II agent.

Several clinical studies have found that the typical marginal fit of inlays, onlays and crowns was in the 120-150 micrometers range. E.g., K. B. May, et al., “Precision of fit: the Procera ALLCeram crown”, J of Prosthetic Dent., 1998, 78, 394-404. A laboratory study of the CEREC I and II systems has shown better fit with gaps in the range 50-80 μm (W. H. Mormann, et al, “Grinding precision and accuracy of fit of CEREC 2 CAD-CIM inlays”, JADA, 128, 47-53); however other studies (both laboratory and clinical) indicate gap widths varying from 52 μm to 282 μm with an average of 165 μm (H. O. Heyman, et al., “The clinical performance of CAD-CAM generated ceramic inlays—a four year study”, JADA, August 1996, 127, 1171-81.) A first attempt to assess accuracy of fit of a digitally produced restoration made by stereolithography according to the present invention demonstrated relatively small gaps in the range 10-50 μm. This first-generation result of an ALL-DIGITAL freeform fabrication approach demonstrates the viability of the concept.

Substantial time savings are realized in the Dental Laboratory supported by this invention due to the replacement of the predominantly “serial” conventional approach with the predominantly “batch” digital approach. Using a modest 4″×4″ stereophotolithography machine, the total estimated laboratory time to build 64 restorations is 18.5 hours vs. 98 hours for the conventional approach. Also of significance is the time savings realized by the dentists using the 3D Intraoral camera (about two min.) versus the conventional impression approach (about 20 min.) for acquiring the restoration site geometry. A single laboratory with a modest capital investment in the software and fabrication equipment could serve a much larger base of dental practices with fewer technicians than existing laboratories using conventional methods. A significant reduction in the cost of polymer composite and ceramic restorations and crowns will result from widespread use of the proposed technology.

The composition of the materials used in the subject invention consist of one or more ceramic particulate material, a photocurable resin, one or more dispersant, and one or more photoinitiators. In a preferred embodiment, the composition additionally includes other additives to tailor rheology and/or the cured properties of the resin.

The ceramic material is preferably of a fine size so as not to substantially contribute to the surface roughness of the restoration (e.g., <1/10 of the layer thickness and dimensional tolerance desired, whichever is smaller). For sinterable compositions, fine particles with high sintering activity at reasonable temperatures are desired to achieve fully dense ceramic bodies. Preferred mean particle sizes are for example from 0.05 microns to 5 microns, preferably from 0.1 microns to 3 microns and most preferably from 0.2 microns to 2 microns.

The ceramic material can be selected from alumina, aluminosilicate, zirconia, mullite, silica, spinel, tricalcium phosphate, apatite, fluoroapatite, hydroxyapatite and mixtures thereof. The ceramic material may include particles of any shape including fibers, rod-shaped particles, spherical particles, or any shape or form of material used in the manufacture of dental restorations. These can be included to increase toughness of the restoration and can be selected from the group consisting of carbon fibers, graphite fibers, silica fibers, alumina fibers, silicon carbide fibers, zirconia fibers, polyaramid fibers, polyacrylonitrile fibers, and mixtures thereof.

The photocurable resin consists of at least one monomer or oligomer with multiple functional groups that allow photocuring. The photocurable materials preferably are organic materials, such as photopolymerizable precursors of one of polyacrylates, polyurethanes, polyesters, vinyl esters, polyamides, epoxies, polycarbonates, and mixtures thereof. Examples include 2(2-ethoxyethoxy) ethylacrylate, trimethylolpropane triacrylate, dipentaerythritol pentaacrylate, and 3,4-epoxycyclohexylmethyl 3,4-epoxycylclohexanecarboxylate.

Preferred photocurable materials include polymerizable (meth)acrylic monomers, such as those described, for example, in U.S. Pat. Nos. 6,186,790, 4,544,359, 6,300,390, and 4,156,766, which are incorporated herein by reference.

The polymer matrix can include polymerization accelerator, polymerization initiators, antioxidants, U.V. light absorbers, plasticizers, antifoaming agents, leveling aids and other additives known in the art.

The photocurable materials preferably are curable upon exposure to actinic radiation, such as visible light or U.V. light, or microwave energy, and so forth. The photocurable material generally contains an effective amount for this purpose of an initiator selected from the group consisting of a U.V. sensitive initiator, a visible light sensitive initiator, and a microwave sensitive initiator. Example suitable U.V. sensitive initiator materials include, for example, bisacylphosphine oxide (BAPO) photoinitiators, such as commercially available Ciba® Irgacure® 819 and Ciba® Irgacure® 2020 products. Examples of suitable visible light sensitive initiator materials include, for example, trimethyl benzoyl phosphine oxide (TPO), and quinone derivatives, such as camphor quinone. The microwave sensitive initiator materials can be, for example, a peroxide derivative, such as benzoyl peroxide.

Dispersants generally are used in said compositions in an amount effective to prevent ceramic particulate agglomerations and to achieve uniform dispersion of ceramic powder within the resin matrix. Often the dispersants are chosen to provide steric, electrostatic, or electrosteric stabilization. Steric dispersants are selected to have an affinity for the particulate surface and a long chain polymer group, which effectively increases particle-particle spacing. Electrostatic dispersants are selected based on the chemistry of the ceramic powder. For powders with basic surface chemistry such as alumina, acidic dispersants are preferred. For powders with low isoelectric points such as silica, cationic dispersants are preferred.

It may be desirable to apply the dispersant to the surface of the ceramic particulates prior to adding the ceramic to the other resin ingredients. This may be accomplished by mixing the ceramic particles and the dispersant in a solvent, followed by evaporation of the solvent.

Whether or not the dispersant is applied to the powder separately or with the other ingredients, it is generally assumed that the dispersant is acting on the surfaces of the ceramic particles preventing their agglomeration due to Van der Waals forces.

The resulting color including but not limited to shade, translucency, and fluorescence, of the restoration can be controlled by addition of pigments, opacifiers, fluorescing agents and the like, added to the layer composition.

The ceramic powder/binder layer forming process is repeated so as to build up the restoration, layer by layer. While the layers become hardened or at least partially hardened as each of the layers is laid down, once the desired final shaped configuration is achieved and the layering process is complete, in some applications it may be desirable that the form and its contents be heated or cured at a suitably selected temperature to further promote consolidation and binding of the ceramic particle components. In either case, whether or not further curing is required, the loose, nonexposed portions of the layers are removed using a suitable technique, such as ultrasonic cleaning, to leave a finished restoration.

While the coating layer binder solution must have a relatively high binder content, the viscosity thereof should be low enough so as to be able to flow under the stresses applied during rapid application of the thin layer coating. The binder material may have a high binding strength as each layer is cured so that, when all the layers have been bonded, the component formed thereby is ready for use without further hardening being necessary. Alternatively, the process may be such as to impart a reasonable strength to the restoration, which is formed, once the restoration is formed it can be further heated or cured to further enhance the consolidation and binding strength of the ceramic particles. In some cases, the binder is removed during such a sintering or firing process, while in others, it or portions of it can remain in the material after firing. Which operation occurs depends on the particular binder material, which has been selected for use and on the conditions, e.g., temperature, under which the heating or firing process is performed. Other post-processing operations may also be performed following the formation of the restoration. The rate at which a ceramic, metal, plastic, or composite restoration can be made depends on the rates used to deposit and pattern the layers, and on the rate at which each bonded layer hardens as the layers are deposited one on the other.

Polymer-matrix composites are particularly suited for direct Freeform Fabrication (DFF) of dental restorations Their advantages over other materials used for lab-produced restorations include a) being readily bonded to tooth structure without an apriori surface treatment, b) have a Young's modulus more closely approaching that of tooth structure, c) are amenable to intra-oral repair, and d) reduce attrition of antagonist dentition over time.

Composite resin properties appropriate for layered manufacturing include:

a) an overall viscosity appropriate for thin film layering and precision polymerization

b) a resin matrix that optimizes ultimate composite strength and the desired modulus

c) a filler fraction that maximizes strength and toughness at the appropriate viscosity

d) an ability to be post-cured.

Matrix resins for polymer matrix composites used for stereolithography preferably comprise a polymerizable composition of one or more resins adapted for use in an oral environment. These resins can comprise one or more esters of ethylenically unsaturated compounds; a coupler; a filler; an initiator; a plasticizer; a stabilizer; and additional additives to pigment the material.

The resins include at least one of 2,2-bis[4-(2-hydroxy-3-methacryloxypropoxy)phenyl)propane, ethyleneglycol dimethacrylate; triethyleneglycol-dimethacrylate; hydroxyethyl methacrylate; and/or a urethane dimethacrylate.

Resins can have acrylate or methacrylate functionalities, and can include 2,2-bis[4-(2-hydroxy-3-methacryloxypropoxy)phenyl)propane, ethyleneglycol dimethacrylate bis-phenol glycidyl dimethacrylate, urethane dimethacrylate, hydroxyethylmethacrylate, triethylene glycol methacrylate, polyethylene glycol, the phosphoric acid ester of pentaerythritol triallyl ether, or the phosphoric acid ester of pentaerythritol pentacrylate. In a preferred embodiment, the resin comprises a mixture of 2,2-bis[4-(2-hydroxy-3-methacryloxypropoxy)phenyl)propane, urethane dimethacrylate, triethylene glycol dimethacrylate, hydroxyethyl methacrylate, and the phosphoric acid ester of dipentaerythritol triallyl ether.

The fillers include glasses, ceramics and inorganic oxides, which are generally the oxides of silicon, aluminum zirconium and other transition metals. Some surface treatments, such as silanization or with titanate, is normally employed before the use of the fillers.

Fillers useful for the composite resin include inorganic fillers comprising ceramics, silicates, glasses, rare earth, or metals. The ceramic filler can comprise alumina, calcium, silica, zirconium, aluminosilicate, silicate, aluminoflurosilicate, or barium.

Metal fillers can be selected from among, for example, gold, silver, gold alloys or silver alloys, individually or in combinations thereof. The rare earth can preferably be comprised of lanthanum.

Organic fillers can be comprised of pre-polymerized co-polymer blocks containing fumed silica.

Titanium dioxide can be added to improve the blade casting properties, in amounts between 0.5 and 10% of the overall weight of the composite formulation.

The total filler concentration can be varied to control the viscosity, and can range from 20 to 95 weight %, and most preferably from 60 to 80 weight %.

Initiators sensitive to UV or visible light are incorporated into the resin to initially harden the composition. They are added in amounts between 0.05 and 5 weight %, preferably between 0.3 and 1.5 weight %, and most preferably between 0.5 and 1.0 weight %. An example of a visible light sensitive initiator is camphorquinone, and an example of a UV sensitive initiator are Irgacure products (CIBA Specialty Chemicals).

A microwave sensitive initiator is also included in the formulation for a secondary hardening of the restoration with microwave energy. Microwave sensitive initiators can include organic peroxides such as preferably benzoyl peroxide, but not excluding dilauroyl peroxide, tert-butyl peroxide. These can be added in amounts between 0.05 and 1.5%, and most preferably between 0.5 and 1.0 weight %.

In the following examples, objects and advantages of this invention are further illustrated by various embodiments thereof but details of those examples should not be construed to unduly limit this invention. All parts and percentages are by weight unless indicated otherwise.

### EXAMPLES

### Example 1

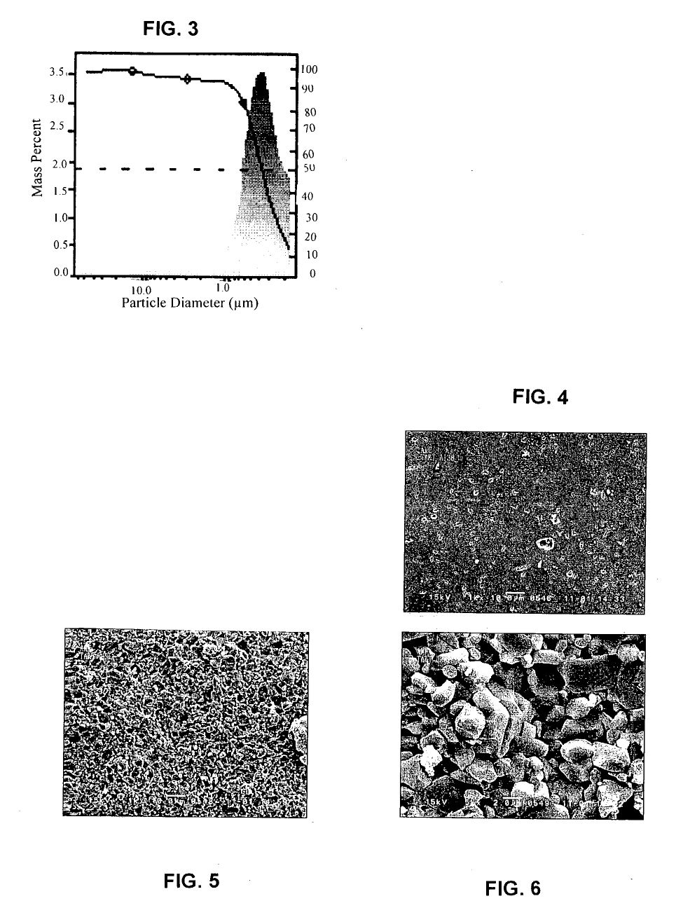

A photocurable ceramic resin composition was prepared by mixing together 55% alkoxylated acrylate, 15% ethoxylated pentaerythritol tetracrylate and 30% plasticizer. To this mix is added 4% anionic dispersant and 1% bis(2,4,6-trimethylbenzoyl)phenylphosphineoxide photoinitiator. These ingredients were measured into an opaque mixing bottle with alumina milling balls (⅜ inch diameter) and ball-milled for 10 minutes prior to adding the alumina powder. A high purity (>99%), sinterable alumina powder (RCHP, Malakoff Ind.) was used with a mean particle size of 0.4 microns. FIG. 3 shows the particle size distribution of the powder. The ceramic powder was added to a concentration of 50% by volume based on the total volume of the mixture and the resin was ball milled for at least 24 hours to breakdown any agglomerates and achieve a smooth, uniform dispersion prior to use.

Prepared resins were characterized by viscosity and photocuring parameters (Working Curve) prior to sample fabrication. Viscosity was measured at room temperature using a Brookfield DV-E viscometer. Viscosity of alumina ceramic photoresin was found to be time independent with the shear rate held constant. The measured viscosity was 1,597,000 cP.

The Working Curve test was performed on the formulation to determine the relationship between exposure dose and depth of cure. The cure depth/exposure dose relationship was derived from the Beer-Lambert Law of absorption, as described by P. F. Jacobs, “Rapid Prototyping & Manufacturing. Fundamentals of Stereolithography”; 1^{st} ed., Society of Manuf. Engineers, 1992, pp. 29-34, and is as follows:

C_{d}=Dₚ ln (Eₘₐₓ/E_{c})

where C_{d} is the depth of cure, Dₚ is the penetration depth, Eₘₐₓ is the exposure dose at the resin surface and E_{c} is the minimum exposure dose required to cause gelation. A semi-log plot of C_{d} versus Eₘₐₓ yields a straight line with a slope equal to Dₚ and an X-axis intercept equal to E_{c}. The working curve of this resin was measured using a UV flood lamp (1000 W Hg/Xe bulb) and a mask to selectively expose the resin for a predetermined time. The thickness of the cured film was measured using calipers after the uncured resin had been removed. The measured values for Ec and Dp were 3.31 mJ/cm² and 0.00623 inches, respectively.

### Example 2

A mixture of two high purity alumina powders were instead added as the ceramic component used with the photocurable resin composition of the formulation used in Example 1. The first alumina powder had a mean particle diameter of 0.4 microns and the second alumina powder had a mean particle diameter of 1.3 microns. The powders were added in equal portions to the resin mixture to a concentration level of 55% by volume. The mixture was ball milled for 24 hours. This ceramic photoresin mixture had a viscosity of 36,800 cP. The photocuring parameters were measured using a HeCd laser operating at 325 nm. The Working Curve parameters for this material was 11.54 mJ/cm² and 0.0026 inches, for Ec and Dp, respectively.

### Example 3

Test samples for material properties assessment were prepared using the alumina resin formulation of Example 2 and a photolithography apparatus modified to allow deposition by blade casting and photocuring of multiple layer samples.

Using this apparatus, simple disk and bar shaped samples were fabricated. In all cases, the layer thickness used was 0.005″ (125 μm), although layers as thin as 0.0005″ (12.5 μm) can be used. An exposure time of 7 seconds was used. Fabricated samples were debound in an air furnace using a heating rate of 1° C./min. to 550° C. to remove the photopolymer. The heating was continued to 1625° C. and the samples were held at this temperature for 4 hours. Density was measured using the Archimedes method, as described in ASTM test method C-20.

Biaxial flexural strength testing was performed following the method described ISO/DIS 6872 standard for dental ceramic. Disk shaped alumina samples nominally 2 mm thick×16 mm diameter were built. A biaxial flexure jig described in ISO/DIS 6872 standard for dental ceramics was used for this test. In this method, the test samples were positioned on three supporting balls spaced equally at the perimeter of a 10.16 mm diameter circle on a flat block. Load was applied from above by a 1.88 mm diameter steel rod to the center of the disk sample. The resulting alumina samples had an average density of 97.7% of theoretical density and an average flexure strength of 478 MPa.

FIGS. 4-6 show scanning electron micrographs of a selected sample made according to this example. The grain size of this material ranges from about 1 micron to about 7-8 microns, with an average grain size of 3-5 microns.

### Example 4

The effect of filler weight percent was investigated using various concentrations of aluminosilicate particles dispersed in a co-monomer blend.

Ground aluminosilicate particles were obtained from Esstech (Essingon, Pa.). As received particles were sieved to remove particles greater than 40 μm. Particle distribution below 40 μm was bimodal, and ranged from 2 to 40 μm. The particles were silanated using a method described by Roulet et al., “Effects of treatment and storage conditions on ceramic/composite bond strength,” J Dent Res 1995, 74, 381-7.

Silanated powder was added to the monomer mixture, to which 1 (wt) % of Irgacure® 2020 (Ciba, Tarrytown, N.Y.), a UV initiator, had been added. The monomer mixture consisted of a 1:1 mole ratio of 2,2-bis[4-(2-hydroxy-3-methacryloxypropoxy)phenyl)propane and triethylene glycol dimethacrylate. A series of composite resin formulations were then made having varying filler concentrations to establish relationships between loading, viscosity and strength. An unfilled resin group was used as a control. All bars were submitted to a 3-point bend test in Instron electromechanical testing instrument and flexural strength determined. The cross head speed for this and all other examples where flexural strength was measured was 2.5 mm/minute.

The flexural strength of various compositions having different filler weight percents are shown in Table 1 below. Flexural strength ranged from 7.9 MPa to 97.5 Mpa. A one-way analysis of variance and Tukey's test indicated that all groups were significantly different from each other.

TABLE 1

| | Flexural | |
|---|---|---|
| | Strength | |
| Group | (MPa) | SD |
| No | 7.9 | 1.5 |
| filler | | |
| 40 (wt) | 38.6 | 4.5 |
| % | | |
| 60 (wt) | 60.0 | 5.3 |
| % | | |
| 80 (wt) | 97.5 | 7.5 |
| % | | |

A series of experimental composites were fabricated to refine particle loading, and test for post-cure effects. This led to the determination that the optimal filler concentration for purposes of direct-layered manufacturing was between 70 and 85%, preferably between 75 and 80%, of which 2% was silanated titanium dioxide.

### Example 5

An assessment of the accuracy of build was made by measuring the bar dimensions. For this purpose, accuracy was defined as shape consistency and conformity to build specifications.

The height and width of bars measuring 25×2×2 mm were measured at five standard points along their length. These values, expressed as a mean and coefficient of variation (CV), were used to define shape consistency. The difference between mean actual and specified desired height/width was expressed as build discrepancy. The measurements, CV and build discrepancy for two batches of a preferred composition having silanated aluminmosilicate glass filler at a 75 weight % concentration in a five part resin matrix is shown in the table below.

The bars were constructed using the blade casting technique. The composition consisted of silanated aluminmosilicate glass filler at a 75 weight % concentration dispersed in a comonomer resin matrix. The matrix contained, by weight, 46% urethane dimethacrylate, 20% 2,2-bis[4-(2-hydroxy-3-methacryloxypropoxy)phenyl)-propane, 30% triethylene glycol dimethacrylate, and 4% hydroxyethylmethacrylate. One weight % of Irgacure 2020 initiator had been added to make the composition UV sensitive.

TABLE 2

| | | Mean Shape | | Build |
|---|---|---|---|---|
| | | Consistency | | Discrepancy |
| Group | Feature | (mm) | CV (%) | (%) |
| A | Height | 1.94 | 1.13 | 3.0 |
| | Width | 1.95 | 0.61 | 2.5 |
| C | Height | 1.96 | 0.78 | 2.0 |
| | Width | 2.01 | 0.95 | 0.5 |

### Example 6

A composite formulation containing 70 (wt) % of aluminosilicate filler was used to determine the effect of post-cure by microwave. The resin matrix composition used is provided in Example 5.

The ceramic composite was made microwave sensitive by the addition of 0.3 (wt) % benzoyl peroxide. Two (wt) % of Irgacure® 2020 (Ciba, Tarrytown, N.Y.), a UV sensitive initiator, was also added.

Bars measuring 25×2×2 mm were fabricated using a modified photolithography apparatus as indicated in Example 3. After fabrication, the bars were subjected to microwave energy at a power setting of 1 KW and for a time period of 60 seconds in a Panasonic home microwave oven. After microwave exposure, flexural strength was determined using the 3-point bend test.

The flexural strength and modulus of the 70 (wt) % composite resins cured by UV light only and post-cured by microwave for 60 seconds are shown below. A Studentized range t-test indicated the difference in means was highly significant (p<0.01).

TABLE 3

| | Flexure Strength | |
|---|---|---|
| Group | Mpa) | SD |
| 70 (wt %)/UV Cure | 60.0 | 3.6 |
| 70 (wt %)/UV + MW Cure | 127.5 | 16.8 |

### Example 7

Using the 77 (wt) % composition, a series of samples was made for mechanical properties determination. These included flexural (FS), diametral tensile (DTS) and compressive (CS) strength. Samples for FS measurements consisted of bars measuring 25×2×2 mm; samples for DTS measurement consisted of disks having a 6 mm diameter and 3 mm thickness; samples for CT tests consisted of cylinders having a length of 8 mm and a diameter of 4 mm. In addition, comparisons for FS only were made to two commercial composite resin materials, Z-100 (3M Dental, Minneapolis, Minn.) and Aelitefil (Bisco, Schaumburg, Ill.). The commercial materials were photo-initiated by a visible light source.

The results of the FS measurements for the UV and microwave cured groups, and the Z-100 and the Aelitefil groups are shown in the table that follows. A one-way analysis of variance and a post hoc test using Tukey's test indicated that the 77 (wt) % group post-cured by microwave radiation had significantly greater FS compared to the other groups (p<0.01). The means for the UV cured-only group and the two commercial materials were not different from each other. A Studentized t-test for the DTS test and a rank-sum test for the CS test (the data were not normally distributed) were used for comparing the UV and microwave curing for both groups. The results indicate microwave curing significantly improved each of the respective mechanical test results.

TABLE 4

| Group | FS (MPa) | DTS (MPa) | Cs (MPa) |
|---|---|---|---|
| 77 (wt) % / UV | 112.5 | 44.9 | 200.0 |
| | (12.6) | | |
| 77 (wt) % / UV + | 162.2 | 54.3 | 247.1 |
| MW | (8.2) | | |
| Z-100 | 126.3 | — | — |
| | (11.5) | | |
| Aelitefil | 107.9 | — | — |
| | (13.8 | | |

As results, microwave post-cure increased FS, DTS and CS for the composites tested.

### Example 8

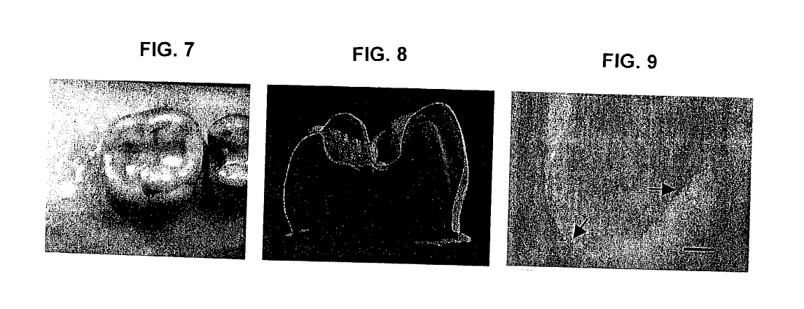

A demonstration fabrication of a restoration made by direct layered manufacturing was made by cutting a Class I inlay cavity preparation into a molar tooth model (FIG. 7). A digital image of the tooth (FIG. 8) was acquired using Genex Technologioes (Kensington, Md.) Rainbow 3D Camera. The image was converted to an STL file using Magics software (Materialise, Inc.) and a replica of the tooth was built by stereolithography using a SLA 250 stereolithography machine by 3D Systems, Inc. To preserve the original tooth model for reuse, the replica with the inlay was sectioned for examination under a stereo microscope.

Using the STL file, a first generation inlay was built using stereolithography resin, viz. DSM 7110 (DSM SOMOS Corp., New Castle, Del.).

The inlay was designed using existing CAD software (Materialise, Inc.) to build a structure that would accurately seat along the defined walls of the preparation. It did not accommodate an occlusal design.

The fabricated inlay was cemented in place in the tooth model replica using a self-curing composite resin luting material. After setting, the tooth was transversely sectioned about every 1.5 mm. The sections were examined using a Nikon stereomicroscope. Images of the sections were captured at 1× magnification with a SONY videocamera, and saved.

FIG. 8 demonstrates a digitized cross-section of the tooth through the cavity preparation. FIG. 9 shows a representative cross-section of the actual tooth model with the fabricated inlay cemented in place. The inlay appears well adapted along the buccal and lingual walls of the preparation. A gap measuring approximately 10 to 50 microns can be observed along the interphase between the inlay and the floor of the preparation.

While the invention has been described in terms of preferred embodiments, those skilled in the art will recognize that the invention can be practiced with modification within the spirit and scope of the appended claims.

1. A method for manufacturing a dental restoration, or dental restorations, comprising:
(a) acquiring a digital image of a three-dimensional topography of a dental restoration site using an intra-oral camera;
(b) creating a data file of the three-dimensional shape of the desired restoration based on the acquired digital image;
(c) depositing a layer comprising photocurable material and ceramic material;
(d) selectively exposing the layer to actinic radiation in a pattern based on the data file effective to define at least a partly hardened pattern therein corresponding to a cross-section of the shape of the restoration at a given thickness level thereof;
(e) repeating steps (c) and (d) a plurality of times to produce a plurality of layers of ceramic composite material stacked on one another and integrally bonded together effective form the three-dimensional shape of the desired restoration; and
(f) hardening the three-dimensional shape to form the dental restoration.

2. The method of claim 1, wherein the data file is a CAD file.

3. The method of claim 1, wherein the photocurable material comprises photopolymerizable precursors of one of polyacrylates, polyurethanes, polyesters, vinyl esters, polyamides, epoxies, polycarbonates, and mixtures thereof.

4. The method of claim 1, wherein the photocurable material comprises acrylate-based polymer precursors.

5. The method of claim 1, wherein the ceramic material is selected from the group consisting of alumina, aluminosilicate, apatite, fluoroapatite, hydroxyapatite, mullite, zirconia, silica, spinel, tricalcium phosphate, and mixtures thereof.

6. The method of claim 1, wherein the ceramic material is selected from the group consisting of sinterable powders of alumina, aluminosilicate, zirconia, hydroxyapatite, tricalcium phosphate, and mixtures thereof.

7. The method of claim 1, wherein the layer further comprises a fibrous material selected from the group consisting of carbon fibers, graphite fibers, silica fibers, alumina fibers, zirconia fibers, polyaramid fibers, polyacrylonitrile fibers, and mixtures thereof.

8. The method of claim 1, wherein the dental restoration is selected from the group consisting of crowns, onlays, inlays, bridges, fillings, denture teeth, and replacement bone.

9. The method of claim 1, wherein the photocurable material contains an initiator selected from the group consisting of a UV sensitive initiator, a visible light sensitive initiator, and a microwave sensitive initiator.

10. The method of claim 1, wherein the actinic radiation source emits actinic radiation within the U.V. light spectrum.

11. The method of claim 1, wherein the actinic radiation source emits photoinitiating light within the visible light spectrum.

12. The method of claim 1, wherein the hardening comprises exposure of the three-dimensional shape to heat effective to sinter the ceramic material.

13. The method of claim 1, wherein the hardening comprises exposure of the three-dimensional shape to microwave energy.

14. The method of claim 1, wherein the three-dimensional shape is separated from non-exposed portions of the layers after either step (e) or step (f) to provide a discrete shaped part.

15. The restoration product of the method of claim 1.

16. The restoration product of the method of claim 14.

17. A dental restoration product made by acquiring a digital image of a three-dimensional topography of a dental restoration site using an intra-oral camera; creating a data file of the three-dimensional shape of the desired restoration based on the acquired digital image; depositing a layer comprising ceramic material and photocurable material containing an initiator selected from the group consisting of a UV sensitive initiator, a visible light sensitive initiator, and a microwave sensitive initiator; selectively exposing the layer to actinic radiation in a pattern based on the data file effective to define at least a partly hardened pattern therein corresponding to a cross-section of the shape of the restoration at a given thickness level thereof; repeating the depositing and selectively exposing steps a plurality of times to produce a plurality of layers of ceramic composite material stacked on one another and integrally bonded together effective form the three-dimensional shape of the desired restoration; and hardening the three-dimensional shape to form a dental restoration product.

18. A method for manufacturing dental restorations, comprising:
(a) acquiring a first digital image of a first three-dimensional topography of a first dental restoration site using an intra-oral camera at a first location;
(b) sending the first digital image electronically to a second location;
(c) creating a first data file of the first three-dimensional shape of the first desired restoration based on the acquired first digital image at the second location;
(d) depositing a layer comprising photocurable material and ceramic filler, at the second location;
(e) selectively exposing the layer to actinic radiation in a pattern based on the data file effective to define at least a partly hardened pattern therein corresponding to a cross-section of the first three-dimensional shape of the first desired restoration at a given thickness level thereof, at the second location;
(f) repeating steps (d) and (e) a plurality of times to produce a plurality of layers of ceramic composite material stacked on one another and integrally bonded together effective form the first three-dimensional shape of the first desired restoration, at the second location;
(g) hardening of the first three-dimensional shape to form the first dental restoration, at the second location;
(h) sending the first dental restoration from the second location to the first location for installation;
(i) acquiring, at a third location different from the first and second locations, a second digital image of a second three-dimensional topography of a second dental restoration site using an intra-oral camera;
(j) sending the second digital image electronically to the second location; and
(k) repeating steps (c) through (h) except for the second digital image instead of the first digital image.

19. The method of claim 18, wherein the sending of the data image comprises transmitting the data image over the internet.

20. The dental restoration product of the method of claim 18.
